(19) United States
(12) Patent Application Publication
(10) Pub. No.: US 2020/0151340 A1
(43) Pub. Date: May 14, 2020

(54) MONITORING A BLOCKCHAIN

(71) Applicant: Siemens Aktiengesellschaft, München (DE)

(72) Inventor: Rainer Falk, Poing (DE)

(21) Appl. No.: 16/629,984

(22) PCT Filed: Jun. 7, 2018
(86) PCT No.: PCT/EP2018/065004

§ 371 Date: Jan. 10, 2020

(30) Foreign Application Priority Data
Jul. 20, 2017 (EP) 17182389.1

(51) Int. Cl. G06F 21/57

(52) U.S. Cl. CPC G06F 21/577; H04L 9/0637; G06F 2221/033

(57) ABSTRACT

Provided is a method for monitoring a blockchain including the following steps: evaluating a characteristic of a physical infrastructure on which the blockchain is based; comparing the determined evaluation to a predetermined parameter; and outputting a signal if the evaluation is less than the predetermined parameter.

### CROSS-REFERENCE TO RELATED APPLICATIONS

This application claims priority to PCT Application No. PCT/EP2018/065004, having a filing date of Jun. 7, 2018, which is based on European Application No. 17182389.1, having a filing date of Jul. 20, 2017, the entire contents both of which are hereby incorporated by reference.

### FIELD OF TECHNOLOGY

The following relates to a blockchain. In particular, the following relates to the monitoring of a blockchain with regard to its trustworthiness.

### BACKGROUND

A blockchain is generally understood as meaning a distributed database, the contents of which are protected from subsequent manipulation by means of cryptographic concatenation. A data record to be stored is linked to a temporally preceding data record by means of a cryptographic hash value. The data records are held in a decentralized manner on a plurality of nodes and are replicated between the nodes.

As long as the sum of the processing powers of the involved nodes is greater than the processing power of an attacker, the blockchain is protected against a hostile takeover and subsequent manipulation. As a result of the high level of security which can be achieved, blockchains are used for crypto currencies such as Bitcoin, for example. Contracts which can relate to conventional life circumstances are also being increasingly protected as smart contracts by means of blockchains. The economic or data value protected by means of a blockchain may be considerable in this case. It is therefore desirable to identify whether or not a blockchain can guarantee a required level of security.

TANGYUZHEETAL: “Social-Aware Decentralization for Secure and Scalable Multi-party Computations”, 2017 IEEE 37TH INTERNATIONAL CONFERENCE ON DISTRIBUTED COMPUTING SYSTEMS WORKSHOPS (ICDCSW), IEEE, Jun. 5, 2017 (2017-06-05), pages 246-251, relates to the selection of nodes in a distributed calculation network on the basis of social relationships between the nodes.

US 2016/275461 A1 proposes subjecting an unknown node to a check before it is accepted for a transaction as part of a blockchain network.

### SUMMARY

An aspect relates to a technique for monitoring a blockchain.

A method for monitoring a blockchain comprises steps of assessing a characteristic of a physical infrastructure on which the blockchain is based; comparing the determined assessment with a predetermined parameter; and outputting a signal if the assessment is less than the predetermined parameter. In this case, the infrastructure comprises a plurality of nodes which are coupled to one another by means of a network, and the characteristic comprises a structure parameter which relates to the infrastructure, its configuration or utilization.

The embodiments of the invention are based on the knowledge that a blockchain forms an inseparable combination of a method with a physical infrastructure and the security or availability of a blockchain can be decisively impaired if a predetermined characteristic of the infrastructure no longer complies with an underlying assumption. A characteristic usually comprises a structure parameter which usually relates to the infrastructure, its configuration or utilization.

The infrastructure conventionally comprises nodes which form physical processing platforms (computer, hardware) for carrying out a method as well as a network. In particular, it is necessary to identify if an infrastructure which was originally configured or planned in a decentralized manner becomes centralistic. In this case, the failure or the hostile takeover of a central node could result in reduced availability or manipulation by third parties.

It is therefore proposed to monitor the infrastructure in order to be able to make a statement on the security of the blockchain or to output a signal or an alarm if the security is no longer guaranteed according to a predetermined standard. This standard can be selected on the basis of an application of the blockchain and can be expressed in the form of the parameter or a set of a plurality of parameters.

As a result, it is possible to identify if the interaction with a blockchain is carried out via a “dummy entity”, that is to say a node which is not sufficiently one of many similar and equally authorized nodes. Such an entity can be produced if the infrastructure is not sufficiently maintained or supported or if the blockchain has become unpopular. The identification makes it possible to prevent, in particular, a critical transaction being carried out on a blockchain which is not sufficiently trustworthy.

Since there is generally no central control of the infrastructure of a blockchain, but rather the infrastructure is provided in a decentralized and self-organizing manner by means of cooperating participants, it is also not possible to reliably predict what the infrastructure actually looks like at a particular time. The infrastructure can be assessed by currently determining at least one characteristic.

The assessment of a characteristic is ultimately a mapping of a system property of the infrastructure to a quantified value in order to enable a comparison with the parameter(s). The conversion of a characteristic into a value can be carried out in different ways.

If the characteristic comprises a numerical value, for example, this value can be adopted, scaled or classified in one of a plurality of predetermined ranges. If the characteristic comprises a geometrical parameter or a topological parameter in the geographical sense, a morphological or statistical consideration can be used to obtain a quantified value. In further embodiments, a single or multiple integration or differentiation or a transform, for example a discrete Fourier transform or a Z transform, of a temporal development of a characteristic is also possible.

A plurality of physical characteristics may be assessed and are compared with associated parameters. In this case, the characteristics and the parameters can each form a vector, wherein the vectors are compared with one another. Furthermore, a plurality of characteristics can each be scaled and added in order to form a weighted sum which can be compared with a predetermined threshold value. The signal may be already output if one of the assessments is less than the associated parameter.

It is assumed in this document that a characteristic assessed as numerically large can be classified as positive with respect to security or availability of the infrastructure. However, a reverse approach is likewise possible; the signal should be output if the assessment falls below the parameter.

In a blockchain, a node usually corresponds to a computer, a computer network or generally a processing unit which can carry out a transaction on the blockchain, in particular in order to append a data block to the blockchain. The node is physically represented by hardware, without which processing cannot be carried out.

Some characteristics are presented below, the influences of which on the security or availability of the blockchain can be assessed.

For example, the characteristic can comprise a number of active nodes in the infrastructure. A node can be considered to be active if it receives or retrieves data relating to transactions to be confirmed or if transaction data can be retrieved by it. The node can be considered to be inactive if, for example, a bandwidth used to transmit transaction data or a number of transaction data items transmitted per unit time falls below a predetermined threshold value. It is thus possible to immediately estimate how many nodes are involved in maintaining the blockchain. The more nodes support the blockchain, the greater the security or the availability of the blockchain may be.

The characteristic can comprise a number of successful nodes in the infrastructure. In order to carry out a transaction in the database of the blockchain, a plurality of nodes may each solve a complicated cryptographic or mathematical problem. The node which solves the problem first is considered to be successful and can receive a reward. A node can be considered to be successful if it solves a predetermined portion of the puzzles presented to it (or overall) first or if the number of puzzles solved by it per unit time exceeds a predetermined threshold value. Unsuccessful nodes can contribute only little or cannot contribute at all to the security of the blockchain since their processing power is shadowed by that of other nodes. The more successful nodes support the blockchain, the greater the security or the availability of the blockchain may be.

The characteristic can comprise a decentralization of successful nodes in the infrastructure. The greater the decentralization, the smaller a difference between the successful numbers per unit time of the individual nodes in the solution of the mathematical problems. Conversely, the decentralization becomes smaller if the difference between the successful numbers per unit time of the nodes becomes larger. The successful number of a node is the number of presented problems solved by the node first. The successful numbers of the nodes per unit time can be represented in a histogram. The smaller the differences between the frequencies entered in the individual classes (bins), the greater the decentralization. Other statistical considerations of the distribution are likewise possible. If, for example, a first node has 1000 successes per minute, but a plurality of other nodes have only 50-100 successes per minute, the decentralization can be smaller than if all nodes have 80-100 successes per minute.

The characteristic can comprise a geographical decentralization of nodes. In this case, the above-described decentralization can be based on a geographical distribution of the nodes. In variants, only active and/or only successful nodes can be respectively considered in this consideration. In other words, it is possible to determine how uniformly the nodes participating in the blockchain are distributed over a geographical region. The more uniform the distribution, the higher the decentralization. The geographical location of a node can be estimated, for example, by analyzing address data relating to a network used for communication. An approximate geographical location of a node can be determined with some certainty, for example on the basis of its IP address (IP: Internet Protocol).

The characteristic can comprise a processing power of all nodes which is available overall. The higher this overall processing power, which is also called the hash power, the greater the processing power must be for a successful attack by a third party. The processing power of a node is tied to its costs, with the result that a large hash power of the nodes in the blockchain makes a successful attack costly and therefore unlikely.

The characteristic can relate to a decentralization of the processing power which is available overall with respect to the nodes in the infrastructure. The more uniformly the hash power is distributed among the individual nodes, the greater the infrastructure-related security or availability may be. In one development, the characteristic may relate to a geographical distribution of the hash power.

The characteristic can also be determined indirectly on the basis of transactions in the blockchain. For example, a number of transactions per block; a number of users setting up transactions; or a number of active smart contracts can be considered. A smart contract can be considered to be active if valid transactions which can be assigned to a smart contract, that is to say can be successfully validated by the smart contract, are confirmed. The smart contract can also be considered to be active if a number of transactions per unit time exceeds a predetermined threshold value.

In another embodiment, a temporal progression of the assessment is generated, wherein a derived variable is determined on the basis of the progression. In particular, a rate of change, the change in the latter or the magnitude of a standard deviation can be determined. The greater one of these values is, the less positively the security or availability of the infrastructure can be assessed. In further embodiments, a jump or a fluctuation in a characteristic can also be considered.

In one development, the falling of an assessment below the parameter can be predicted on the basis of the temporal progression of the assessment. For example, a trend analysis can be carried out, for instance on the basis of a linear regression. The signal can already be output when there is a threat of the parameter being undershot in a shorter time than a predetermined time.

An apparatus for monitoring a blockchain comprises an interface for connection to at least one node in the blockchain; an interface for outputting a signal; and a processing device for carrying out the method described herein. The connection to the node can be effected, in particular, via a network.

### BRIEF DESCRIPTION

Some of the embodiments will be described in detail, with reference to the following figures, wherein like designations denote like members, wherein:

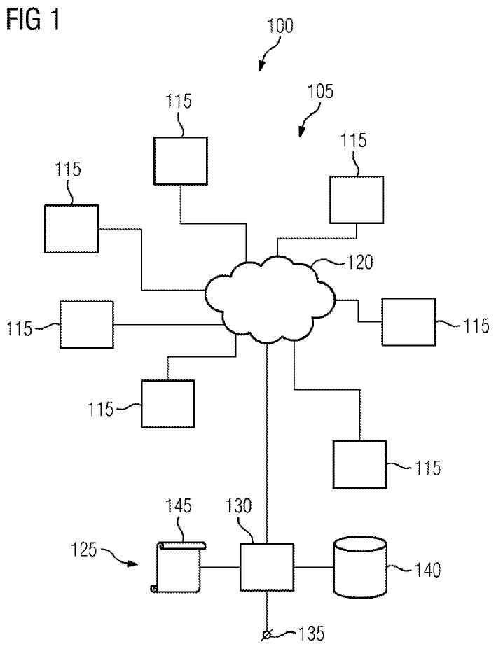

FIG. 1 shows a system having a blockchain in one embodiment;

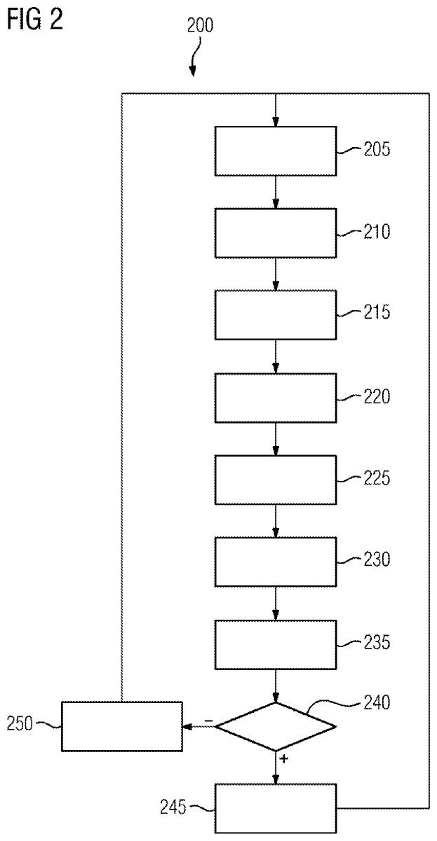

FIG. 2 shows a flowchart of an exemplary method for monitoring a blockchain; and

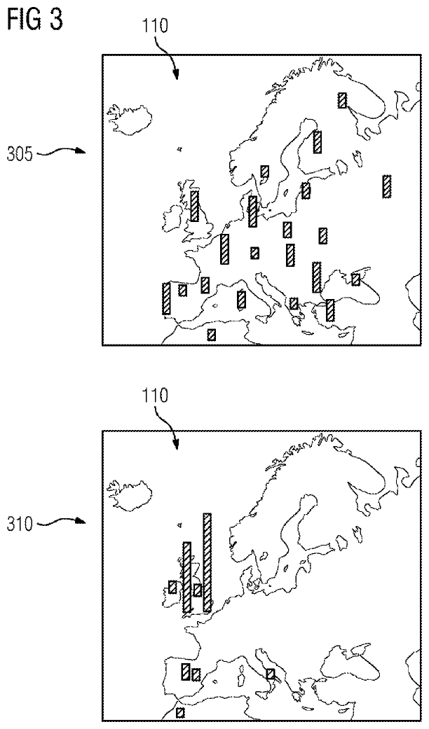

FIG. 3 shows illustrations of characteristics of two fictitious blockchain infrastructures.

### DETAILED DESCRIPTION

FIG. 1 shows a system 100 which implements a blockchain 105, for example Bitcoin or Ethereum. The blockchain 105 comprises a distributed infrastructure 110 which carries out a blockchain method (not shown) jointly or in a plurality of entities. The infrastructure 110 comprises a plurality of nodes 115 (miners) coupled to one another by means of a network 120. Each node is implemented by means of at least one physical processing device. The network 120 can be included in the infrastructure 110 or can be considered to be an underlying service.

An apparatus 125 comprises a processing device 130, a first interface 132 and optionally a second interface 135 and/or a storage apparatus 140. The first interface 132 may be connected to the network 120 in order to be able to communicate with one of the nodes 115 if possible. A plurality of nodes 115 can be reached, from which one can be selected for communication. A communication protocol of the blockchain, a transport protocol of the network 120 (for example TCP/IP) or another protocol can be used for communication.

In one embodiment, a process which provides parameters of the node 115 via the network 120 respectively runs on one or more of the nodes 115. The parameters may include, in particular, an available or used network bandwidth, an available or used processing power or another transaction or processing parameter of the node 115 which is based on the blockchain 105.

The apparatus 125 can be set up to cause or check a transaction in the blockchain 105 or to be notified of a transaction. A service, a method or an offer, which is intended to be protected by means of the blockchain 105, can be associated with this. The security of the service can depend on the blockchain 105 having a predetermined degree of availability or security.

It is proposed to use the apparatus 125 to check the prerequisites of the infrastructure 110 for guaranteeing availability or security of the blockchain 105.

The apparatus 125 may be set up to determine a characteristic by communicating with one or more nodes 115 or by observing communication of one or more nodes 115, which characteristic distinguishes the infrastructure 110 of the blockchain 105. The apparatus 125 may also be set up to assess the characteristic by assigning a numerical value to it and comparing this value with a predetermined parameter 145. If the comparison is negative, that is to say if the determined value is not on a desired, predetermined side of the parameter, a signal can be output via the interface 135. The determination and assessment of the characteristic and the comparison with the parameter 145 are selected in this case in such a manner that the signal indicates that a predetermined property of the infrastructure 110 is no longer valid or is about to be no longer valid, with the result that security and/or availability of the blockchain 105 could be in danger.

The apparatus 125 may operate only on the infrastructure 110 of the blockchain 105. A security analysis of the blockchain method running on the nodes 115 should likewise be carried out independently thereof, but is not the subject matter of embodiments of the present invention. The functionality of the apparatus 125 described herein can alternatively also be implemented as an independent service on a cloud platform. Furthermore, the service can also run on one of the nodes 115.

FIG. 2 shows a flowchart of an exemplary method 200 for monitoring a blockchain 105. The method 200 is set up, in particular, to run on the apparatus 125 from FIG. 1 and or on the processing device 130 thereof which can comprise a programmable microcomputer or microprocessor, for example. The method 200 can be in the form of a computer program product (non-transitory computer readable storage medium having instructions, which when executed by a processor, perform actions) with program code means. Features or advantages of the method 200 can be based on the apparatus 125 or vice versa.

In a step 205, it is possible to capture one or more parameters 145 which can be selected on the basis of a service which is intended to be protected by means of the blockchain 105.

In a step 220, it is possible to determine one or more nodes 115 which are included in the infrastructure 110. In a step 215, one or more of the determined nodes 115 can be sensed. The sensing can be carried out actively by communicating with the node 115 or passively by determining information relating to the node 115. Furthermore, one or more transactions which are carried out on the blockchain 105 can be determined or observed in a step 220. In a step 225, communication information relating to one or more nodes 115 can be determined. This information can relate, for example, to a bandwidth used for the requirements of the blockchain 105, a number or frequency of particular messages or address information relating to the node 115 or communication with the node 115. The determined information can be stored in the storage apparatus 140 in a step 230 and/or can be brought into context with information previously stored there. It should be noted that some of the stated steps 210-230 can also be carried out in another order, repeatedly and/or at a different frequency.

The determined information is assessed in a step 235 by assigning a quantitatively comparable, such as a numerical value to an item of information indicating a predetermined characteristic of the infrastructure 110. One or more assessments are compared with one or more parameters 145 in a step 240. By way of example, it is assumed that a high assessment of a characteristic indicates a positive influence of the infrastructure 110 on the security or availability of the blockchain 105 and a lower assessment indicates a less positive influence. A measure of security and/or availability of the blockchain 105 can therefore be determined on the basis of the determined assessment(s).

If it was determined in step 240 that the value is below the parameter 145, a signal can be output in a step 245, in particular via the interface 135. If a plurality of assessed characteristics have been compared with a plurality of parameters 145, the type of comparison can specify whether or not the signal is already output if only one value falls below the associated parameter. In one embodiment, a plurality of characteristics are considered and their deviations are summed in a weighted manner. The signal can be output only when the sum exceeds a predetermined, further threshold value.

The signal may be directed to a person and may be presented, for example, optically, acoustically or haptically. However, the signal may also comprise an item of information which is directed to the person, a method or a process. For this purpose, the signal may be provided, for example, as an electrical switching signal, as a switching contact, as a warning light, as a notification on a display or else in the form of a message, for example as an SNMP trap, MQTT message or via OPC UA.

Furthermore, the test information or the determined characteristics can be stored or protected in a log database or a blockchain 105. The entries may be protected by a cryptographic checksum (digital signature, message authentication code) of the apparatus 125. This also makes it possible to subsequently check whether a required structural specification in the form of a valid parameter set was complied with at a certain time or period in the past. Depending on this circumstance, transactions confirmed in the blockchain 105 in this period can be treated as valid or invalid or unconfirmed.

In developments, a plurality of parameters 145 or parameter sets can be stored for different services or by different users of the blockchain infrastructure 110. Accordingly, it is possible to provide different signals which are each assigned to one of the parameter sets. As a result, signals of different urgency can also be provided if, for example, the security or availability of the infrastructure 110 gradually deteriorates.

In particular, the signal can be evaluated by the service which is intended to be protected by means of the blockchain 105 or by a component supervising the service. If the signal is present, a predetermined transaction can be triggered in the blockchain 105, for example, or transactions in the blockchain 105 can be deliberately suspended.

In contrast, if it was determined in step 240 that a signal does not need to be output, a signal which has already been output can be deleted or revoked in a step 250. The method 200 can then return to the start and can run through again.

The method 200 can be carried out permanently or at a predetermined frequency, for example hourly or daily.

FIG. 3 shows illustrations of selected characteristics of two fictitious infrastructures 110 of a blockchain 105. A first illustration 305 relates to an infrastructure 110, on the basis of which a secure, available and trustworthy blockchain 105 can be implemented. A second illustration 310 relates to an infrastructure 110 which hampers or prevents implementation of a secure, available and trustworthy blockchain 105.

Both illustrations 305, 310 are based, by way of example, on a geographical map comprising Europe, for example. Depicted vertical bars correspond to exemplary characteristics of individual nodes 115 in the respective infrastructure 110. The positions of the bars can indicate a location of the associated node 115.

The length of the illustrated bars can reflect one of the following characteristic variables of a node 115:
an available or used processing power;
an available or used network bandwidth;
a number of transactions carried out per unit time;
a number of successes per unit time;
a number of users setting up transactions on this node 115 per unit time; or
a number of active smart contracts.

The infrastructure 110 illustrated in the first illustration 305 can be assessed as positive based on predetermined parameters or in comparison with the infrastructure 110 in the second illustration 310 because:
the nodes 115 are locally distributed in a relatively uniform manner;
the local distribution spans a larger area;
the nodes 115 are set up in a larger number of different countries;
the characteristic variable represented by the bars does not vary too excessively across the nodes 115; or
the sum of the characteristic variable across all nodes 115 is large.

For corresponding reasons, the infrastructure 110 shown in the second illustration 310 can be assessed as less positive or even negative with respect to its influence on the security or availability of the blockchain 105.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for monitoring a blockchain, wherein the method comprises the following steps:
assessing a characteristic of a physical infrastructure on which the blockchain is based,
wherein the infrastructure comprises a plurality of nodes which are coupled to one another by means of a network;
comparing the determined assessment with a predetermined parameter; and
outputting a signal if the assessment is less than the predetermined parameter,
wherein the characteristic comprises a structure parameter which relates to the infrastructure, the infrastructure's configuration or the infrastructure's utilization.

2. The method as claimed in claim 1, wherein a plurality of physical characteristics are assessed and are compared with associated parameters, and the signal is output if one of the assessments is less than the associated parameter.

3. The method as claimed in claim 1, wherein the characteristic comprises a number of active nodes in the infrastructure.

4. The method as claimed in claim 1, wherein the characteristic comprises a number of successful nodes in the infrastructure.

5. The method as claimed in claim 1, wherein the characteristic comprises a decentralization of successful nodes in the infrastructure.

6. The method as claimed in claim 1, wherein the characteristic comprises a geographic decentralization of nodes.

7. The method as claimed in claim 1, wherein the characteristic comprises a processing power of all nodes which is available overall.

8. The method as claimed in claim 1, wherein the characteristic relates to a decentralization of the processing power which is available overall with respect to the nodes in the infrastructure.

9. The method as claimed in claim 1, wherein the characteristic is determined on the basis of transactions in the blockchain.

10. The method as claimed in claim 1, wherein a temporal progression of the assessment is generated and a derived variable is determined on the basis of the progression.

11. The method as claimed in claim 10, wherein the falling of the assessment below the parameter is predicted on the basis of the progression.

12. An apparatus for monitoring a blockchain, wherein the apparatus comprises the following:
an interface for connection to at least one node in the blockchain;
an interface for outputting a signal; and
a processing device for carrying out a method as claimed in claim 1.
